(19) United States
(12) Patent Application Publication
(10) Pub. No.: US 2023/0365379 A1
(43) Pub. Date: Nov. 16, 2023

(54) SOLUTION FOR DETECTING A MAINTENANCE MODE OPERATION OF AN ELEVATOR SYSTEM

(71) Applicant: KONE Corporation, Helsinki (FI)

(72) Inventors: Matti Mustonen, Helsinki (FI); Matti Laakso, Helsinki (FI)

(73) Assignee: KONE Corporation, Helsinki (FI)

(21) Appl. No.: 18/226,072

(22) Filed: Jul. 25, 2023

Related U.S. Application Data
(63) Continuation of application No. PCT/EP2021/055743, filed on Mar. 8, 2021.

(51) Int. Cl. B66B 5/00; B66B 5/06

(52) U.S. Cl. CPC B66B 5/0025; B66B 5/06

(57) ABSTRACT

A method for detecting a maintenance mode operation of an elevator system includes obtaining, by a monitoring unit being a separate unit arranged to an elevator car of the elevator system, motion data of the elevator car representing at least one drive motion profile of the elevator car; comparing, by the monitoring unit, the obtained motion data to at least one respective reference motion profile of the elevator car; detecting, by the monitoring unit, at least one deviation between the obtained motion data and the respective at least one reference motion pro-file, wherein the at least one deviation indicates at least one maintenance related operation; and detecting, by the monitoring unit, the maintenance mode operation of the elevator system in response to the detection of the at least one deviation. A monitoring unit, an elevator system, and a computer program for detecting a maintenance mode operation of an elevator system are also disclosed.

### TECHNICAL FIELD

The invention concerns in general the technical field of elevator systems. Especially the invention concerns services of elevator systems.

### BACKGROUND

Typically, a remote monitoring unit, e.g. a service center, may receive continuously, i.e. around the clock, information from one or more elevator systems. For example, the remote monitoring unit may receive fault codes from the one or more elevator systems and generate automatic service needs, based on the received fault codes, e.g. to maintenance personnel. During a normal maintenance visit, e.g. by the maintenance personnel, one or more maintenance operations may cause generation of one or more unnecessary fault codes to the remote elevator monitoring unit. These unnecessary fault codes, in turn, may lead to the generation of unnecessary automatic service needs. Therefore, the unnecessary fault codes may decrease the accuracy of the generated service needs and increase unnecessary maintenance visits.

Thus, there is a need to develop solutions in order to improve at least partly efficiency of a maintenance of an elevator system.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, a monitoring unit, an elevator system, a computer program, and a computer-readable medium for detecting a maintenance mode operation of an elevator system. Another objective of the invention is that the method, the monitoring unit, the elevator system the computer program, and the computer-readable medium for detecting a maintenance mode operation of an elevator system improve efficiency of a maintenance of the elevator system.

The objectives of the invention are reached by a method, a monitoring unit, an elevator system, a computer program, and a computer readable medium as defined by the respective independent claims.

According to a first aspect, a method for detecting a maintenance mode operation of an elevator system is provided, wherein the method comprises: obtaining, by a monitoring unit being a separate unit arranged to an elevator car of the elevator system, motion data of the elevator car representing at least one drive motion profile of the elevator car; comparing, by the monitoring unit, the obtained motion data to at least one respective reference motion profile of the elevator car; detecting, by the monitoring unit, at least one deviation between the obtained motion data and the respective at least one reference motion profile, wherein the at least one deviation indicates at least one maintenance related operation; and detecting, by the monitoring unit, the maintenance mode operation of the elevator system in response to the detection of the at least one deviation.

The method may further comprise generating to a remote monitoring unit an indication indicating the maintenance mode operation of the elevator system.

The motion data of the elevator car may comprise an acceleration profile of the elevator car, a speed profile of the elevator car, a position profile of the elevator car, and/or a jerk profile of the elevator car.

Alternatively or in addition, each at least one reference motion profile of the elevator car may represent a motion profile characteristic of the elevator car, when the elevator system is operating in a normal operation mode.

The generated indication may further comprise an instruction to ignore subsequent fault codes from said elevator system.

Alternatively or in addition, the method may further comprise: continuing the obtaining of the motion data of the elevator car and the comparing of the obtained motion data to the at least one respective reference drive motion profile of the elevator car after the generating the indication, detecting an ending of the deviation between the obtained motion data and the at least one respective reference drive motion profile, and generating to the remote monitoring unit a second indication indicating the ending of the maintenance mode operation of the elevator system.

The second indication may further comprise an instruction to terminate the ignoring of the subsequent fault codes from said elevator system.

According to a second aspect, a monitoring unit for detecting a maintenance mode operation of an elevator system is provided, wherein the monitoring unit is a separate control unit arranged to an elevator car of the elevator system and comprises: a processing unit, and a memory unit comprising a computer program code, wherein the memory unit and the computer program code are configured to, with the processing unit, cause the monitoring unit at least to: obtain motion data representing at least one motion profile of the elevator car, compare the obtained motion data to at least one respective reference motion profile of the elevator car, detect at least one deviation between the obtained motion data and the respective at least one reference motion profile, wherein the at least one deviation indicates one or more maintenance related operations, and detect the maintenance mode operation of the elevator system in response to the detection of the at least one deviation.

The monitoring unit may further be configured to generate to a remote monitoring unit an indication indicating the maintenance mode operation of the elevator system.

The motion data may comprise an acceleration profile of the elevator car, a speed profile of the elevator car, a position profile of the elevator car, and/or a jerk profile of the elevator car.

Alternatively or in addition, each at least one reference motion profile of the elevator car may represent a motion profile characteristic of the elevator car, when the elevator system is operating in a normal operation mode.

The generated indication may further comprise an instruction to ignore subsequent fault codes from said elevator system.

Alternatively or in addition, the monitoring unit may further be configured to: continue the obtaining of the motion data and the comparing of the obtained motion data to the at least one respective reference drive motion profile of the elevator car after generating the indication, detect an ending of the deviation between the obtained motion data and the at least one respective reference drive motion profile of the elevator car, and generate to the remote monitoring unit a second indication indicating the ending of the maintenance mode operation of the elevator system.

The second indication may further comprise an instruction to terminate the ignoring of the subsequent fault codes from said elevator system.

According to a third aspect, an elevator system for detecting a maintenance mode operation of an elevator system is provided, wherein the elevator system comprises: at least one elevator car, and a monitoring unit described above.

According to a fourth aspect, a computer program is provided, wherein the computer program comprises instructions which, when the program is executed by a control unit described above, cause the control unit to carry out the method described above.

According to a fifth aspect, a tangible non-volatile computer-readable medium is provided, wherein the tangible non-volatile computer-readable medium comprises the computer program described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system according to the invention.

FIG. 2 illustrates schematically an example of a typical drive motion profile of an elevator car according to the invention.

FIG. 3 illustrates schematically an example of a method according to the invention.

FIGS. 4A-4C illustrate schematically examples of obtained motion data of an elevator car and a respective reference motion profile of the elevator car.

FIG. 5 illustrates schematically another example of a method according to the invention.

FIG. 6 illustrates schematically an example of components of a monitoring unit according to the invention.

### DESCRIPTION OF THE EXEMPLIFYING EMBODIMENTS

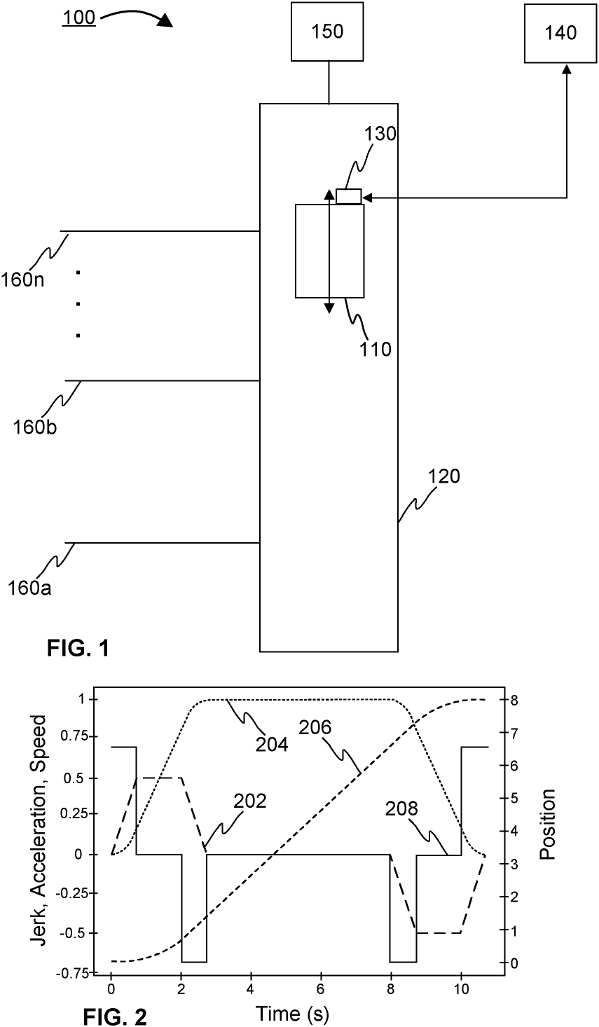

FIG. 1 illustrates schematically an example of an elevator system 100 according to the invention. The elevator system 100 according to the invention comprises at least one elevator car 110 configured to travel along a respective at least one elevator shaft 120 between a plurality of landings 160a-160n, an elevator control system 150, and a monitoring unit 130. The example elevator system 100 of FIG. 1 comprises one elevator car 110 travelling along one elevator shaft 120, however the elevator system 100 may also comprise an elevator group, i.e. group of two or more elevator cars 110 each travelling along a separate elevator shaft 120 configured to operate as a unit serving the same landings 160a-160n. The elevator control system, e.g. an elevator control unit, 150 may be configured to control the operation of the elevator system 100 at least in part. The elevator control system 150 may reside e.g. in a machine room (for sake of the clarity not shown in FIG. 1) or in one of the landings 160a-160n of the elevator system 100. The monitoring unit 130 is a separate unit arranged to the elevator system 100. In other words, the monitoring unit 130 is independent of the elevator control system 150 of the elevator system 100. The monitoring unit 130 may be arranged for example to an elevator car 110 of the elevator system (100), for example to a rooftop of the elevator car 110. The monitoring unit 130 may be configured to obtain elevator related data of the elevator system 100, e.g. motion data of the elevator car 110, indirectly. For example, if the monitoring unit 130 is not able to communicate with the elevator control system 150, i.e. there is no access to a communication interface of the elevator control system 150, and thus cannot obtain elevator related data from the elevator control system 150 of the elevator system 100, the monitoring unit 130 may obtain the elevator related data indirectly, e.g. by one or more sensor devices 650 of the monitoring unit 130. Alternatively or in addition, the monitoring unit 130 may be configured to obtain the elevator related data directly from the elevator control system 150 of the elevator system 100, if the monitoring unit 130 is able to communicate with the elevator control system 105. The monitoring unit 130 may comprise one or more sensor devices 650 configured to obtain the elevator related data. The one or more sensor devices 650 of the monitoring unit 130 may comprise for example, but is not limited to, at least one accelerometer, at least one magnetometer, at least one gyroscope, at least one pressure sensor, at least one temperature sensor, at least one humidity sensor, and/or at least one microphone, etc.. The one or more sensor devices 650 may be internal and/or external to the monitoring unit 130. The one or more external sensor devices 650 may be communicatively coupled to the monitoring unit 130. The monitoring unit 130 arranged to the elevator system 100 enables that the elevator related data may be obtained for example in implementations where there is no access to the communication interface of the elevator control system 150, e.g. if the elevator system 100 is a third party elevator system. The communication to and from the monitoring unit 130 may be based on one or more known communication technologies, either wireless or wired, so that the communication between the monitoring unit 130 and any other entity may be established as described throughout this application. The implementation of the monitoring unit 130 may be done as a stand-alone unit or as a distributed control environment between a plurality of stand-alone units providing distributed processing resource.

The elevator system 100 according to the invention may further comprise one or more other known elevator related entities, e.g. hoisting system, user interface devices, safety circuit and devices, elevator door system, etc., which are not shown in FIG. 1 for sake of clarity.

The elevator system 100 according to the invention may further comprise or at least be associated with a remote monitoring unit 140. The remote monitoring unit 140 may be located on-site, i.e. at the elevator system 100, or off-site, i.e. external to the elevator system 100, e.g. cloud server -based remote monitoring unit. The remote monitoring unit 140 may be e.g. a cloud server, a service center, a maintenance center, or a data center. The remote monitoring unit 140 may receive fault codes from the elevator system 100, e.g. from the elevator control system 150 and/or from the monitoring unit 130. The remote monitoring unit 140 may further generate, service needs e.g. maintenance orders, based on the received fault codes from the elevator system 100, for example to at least one maintenance person. The control unit 130 and the remote monitoring unit 140 may be communicatively coupled to each other. The communication between the control unit 130 and the remote monitoring unit 140 may be based on one or more known communication technologies, either wired or wireless.

A drive motion profile of an elevator car 110 represents a motion of said elevator car as a function of time during at least one travel, i.e. journey, of the elevator car 110. The drive motion profile of the elevator car 110 may be an acceleration profile of the elevator car 110, a speed profile of the elevator car 110, a position profile of the elevator car 110, or a jerk, i.e. change of the acceleration, profile of the elevator car 110. FIG. 2 illustrates schematically non-limiting examples of the drive motion profiles characteristic of an elevator car 110, when the elevator system 100 is operating in a normal operation mode. In other words, FIG. 2 illustrates schematically non-limiting examples of typical drive motion profiles 202-208 of an elevator car 110 when the elevator system 100 is operating in the normal operation mode. With the term “normal operation mode of an elevator system” is meant throughout this application an operation mode of an elevator system 100, in which the at least one elevator car 110 is configured to travel along the elevator shaft 120 and convey, i.e. serve, people and/or load between the plurality of floors 160a-160n. The example drive motion profiles 202-208 of the elevator car 110 of FIG. 2 comprises the acceleration profile 202 of the elevator car 110, the speed profile 204 of the elevator car 110, the position profile 206 of the elevator car 110, and the jerk profile 208 of the elevator car 110. The values presented in the example of FIG. 2 are only non-limiting example values for the acceleration, speed, jerk, and/or position of the elevator car 110 and/or for the time. According to the example drive motion profiles 202-208 of the elevator car 110, the elevator car 110 accelerates from a stationary state to a constant speed state, e.g. a nominal speed of the elevator car 110, and from the constant speed the elevator car 110 decelerates back to the stationary state. The acceleration may be increasing acceleration, decreasing acceleration, and/or constant acceleration. Similarly, the deceleration may be increasing deceleration, decreasing deceleration, and/or constant deceleration.

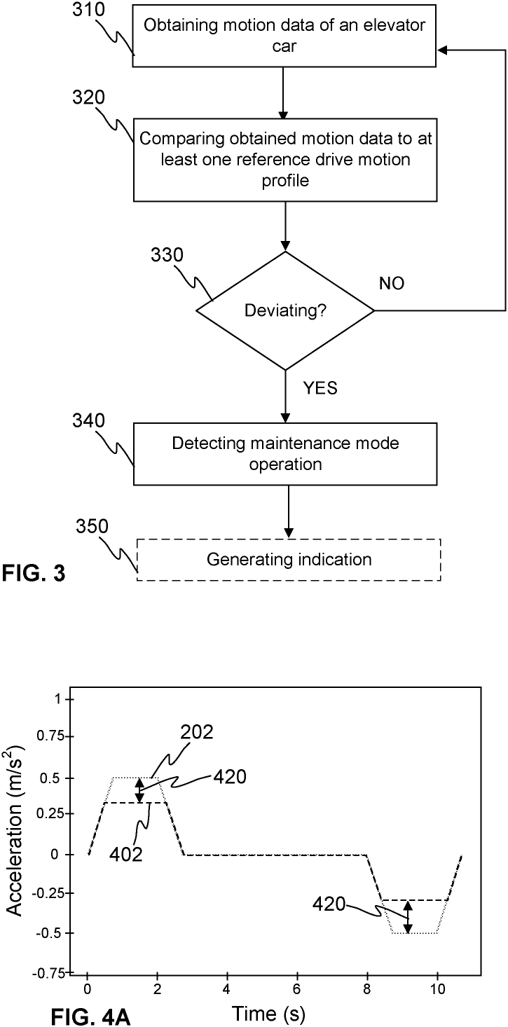

Now, at least some aspects of the present invention are described by referring to FIG. 3 in which an example of a method for detecting a maintenance mode operation of an elevator system 100, i.e. that the elevator system 100 is operating in a maintenance operation mode, is schematically illustrated. As discussed above, if the monitoring unit 130 is able to communicate with the elevator control system 150 of the elevator system 100, the monitoring unit 130 may obtain elevator related data, e.g. motion data of the elevator car 110, directly from the elevator control system 150 of the elevator system 100. In that case the monitoring unit 130 may detect the maintenance mode operation of the elevator system 100 directly by detecting an activation of the maintenance operation mode, e.g. an activation of a maintenance operation mode switch. The present invention enables further a detection of the maintenance mode operation of the elevator system 100, when the monitoring unit 130 is not able to communicate with the elevator control system 150 of the elevator system 100 and thus cannot directly detect the activation of the maintenance operation mode. Alternatively or in addition, the solution for detecting of the maintenance operation mode operation of the elevator system 100 according to the invention may be used also when the monitoring unit 130 is able to communicate with the elevator control system 150 of the elevator system 100 and thus able to detect the maintenance mode operation of the elevator system 100 by detecting the activation of the maintenance operation mode.

At a step 310, the monitoring unit 130 obtains motion data representing at least one drive motion profile of the elevator car 110 of the elevator system 100. The motion data may be obtained by at least one sensor device of the one or more sensor devices 650 of the monitoring unit 130, for example, but not limited to, the at least one accelerometer. The obtained motion data may comprise an acceleration profile of the elevator car 110, a speed profile of the elevator car 110, a position profile of the elevator car 110, and/or a jerk profile of the elevator car 110. In other words, the monitoring unit 130 obtains data representing the acceleration of the elevator car 110 as a function of time, the speed of the elevator car 110 as a function of time, the location of the elevator car 110 as a function of time, and/or the jerk of the elevator car 110 as a function of time.

At a step 320, the monitoring unit 130 compares the obtained motion data to at least one respective, i.e. corresponding, reference drive motion profile of the elevator car 110. Each of the at least one reference motion profile of the elevator car 110 may represent a drive motion profile characteristic of the elevator car 110, when the elevator system 100 is operating in a normal operation mode. The at least one reference drive motion profile of the elevator car 110 may comprise a reference acceleration profile of the elevator car 110, a reference speed profile of the elevator car 110, a reference position profile of the elevator car 110, and/or a reference jerk profile of the elevator car 110. According to a non-limiting example, the at least one reference drive motion profile of the elevator car 110 may correspond to one or more of the example drive motion profiles 202-208 illustrated in FIG. 2. In other words, at the step 320 the monitoring unit 130 compares the obtained at least one drive motion profile of the elevator car 110 to the at least one corresponding reference drive motion profile of the elevator car 110. For example, if the obtained motion data comprises the acceleration profile of the elevator car 110, the speed profile of the elevator car 110, the position profile of the elevator car 110, and the jerk profile of the elevator car 110, the monitoring unit 130 may compare the obtained acceleration profile of the elevator car 110 to the reference acceleration profile, the obtained speed profile of the elevator car 110 to the reference speed profile, the obtained position profile of the elevator car 110 to the reference speed profile, and/or the obtained jerk profile of the elevator car 110 to the reference jerk profile.

At a step 330, the monitoring unit 130 detects at least one deviation between the obtained motion data and the respective at least one reference motion profile, wherein the at least one deviation indicates one or more maintenance related operations of the elevator system 100. In other words, the at least one deviation may indicate that one or more maintenance related operations of the elevator system 100 may be in progress, i.e. going on, for example by at least one maintenance person. The indication of the one or more maintenance operations of the elevator system 100, in turn may indicate that the elevator system 100 is in the maintenance operation mode. When the elevator system 100 is in the maintenance operation mode a maintenance person, e.g. a technician, may control, i.e. drive, the elevator car 110 along the elevator shaft 120, while providing one or more maintenance operations, e.g. checking the elevator shaft 120 condition. The controlling of the elevator car 110 during the maintenance operation mode may be performed by the maintenance person for example from the roof of the elevator car 110 via a user interface device, e.g. a maintenance access panel (MAP). Alternatively or in addition, the controlling of the elevator car 110 in the maintenance operation mode by the maintenance person may comprise use of two buttons of the user interface device to enable the maintenance mode in the elevator control system 150. The at least one drive motion profile of the elevator car 110 in the maintenance operation mode may deviate from the at least one drive motion profile of the elevator car 110, when the elevator system is operating in the normal operation mode for example, but is not limited to, in the following ways:
a) the jerk and/or a maximum acceleration of the elevator car 110 may have lower values in the maintenance operation mode to produce smoother and slower drive motion profile;
b) the maximum speed of the elevator car 110 may be substantially slower in the maintenance operation mode, e.g. in the maintenance operation mode the maximum speed of the elevator car 110 may be e.g. 0.3 m/s or even slower, e.g. 0.03 m/s, whereas according to the speed profile of the elevator car 110, when the elevator system 100 is operating in the normal operation mode, the maximum speed of the elevator car 110 may be, e.g. 1.0 m/s;
c) the jerk in the deceleration of the elevator car 110 and the deceleration values in a stopping phase of the elevator car 110 may have lower values in the maintenance operation mode; and/or
d) stopping of the elevator car 110 may have different at least one motion profile, for example in the maintenance mode operation fast speed/torque ramps may be used instead of smoothed at least one drive motion profile of the elevator car 110, when the elevator system 100 is operating in the normal operation mode.

If the monitoring unit 130 detects for example at least one of the above-mentioned example deviations a)-d) between the obtained motion data and the respective at least one reference motion profile, it may indicate that the one or more maintenance related operations of the elevator system 100 may be in progress, which in turn may indicate that the elevator system 100 is in the maintenance operation mode.

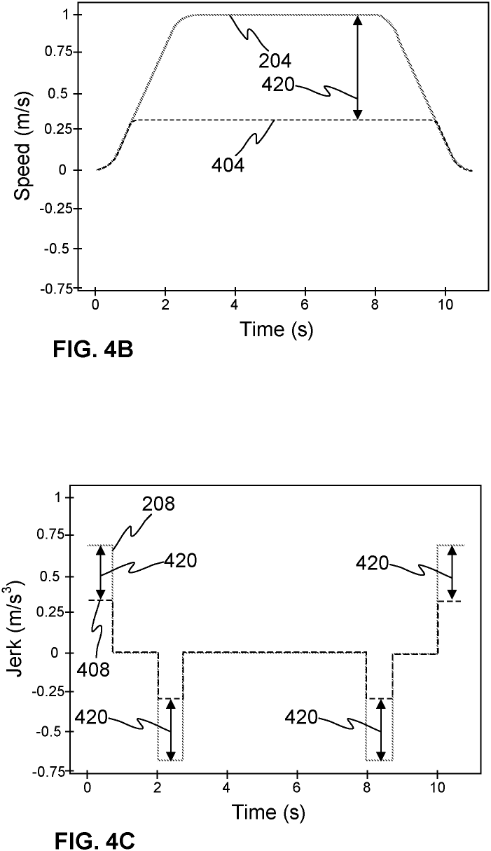

FIGS. 4A-4C illustrate schematically some non-limiting examples of the at least one deviation between the obtained motion data of the elevator car 110 and the respective at least one reference motion profile of the elevator car 110. FIG. 4A illustrates schematically an example of the at least one deviation 420 between the obtained acceleration profile 402 and the reference acceleration profile 202. In the example of FIG. 4A the maximum acceleration in the obtained acceleration profile 402 is lower than the maximum acceleration in the reference acceleration profile 202, which may be considered as the indication of the maintenance mode operation of the elevator car 110. FIG. 4B illustrates schematically an example of the at least one deviation 420 between the obtained speed profile 404 and the reference speed profile 204. In the example of FIG. 4B the maximum speed in the obtained speed profile 404 is lower than the maximum speed in the reference speed profile 204, which may be considered as the indication of the maintenance mode operation of the elevator car 110. FIG. 4C illustrates schematically an example of the at least one deviation 420 between the obtained jerk profile 408 and the reference jerk profile 208. In the example of FIG. 4C the jerk in the obtained jerk profile 408 is lower than the jerk in the reference jerk profile 208, which may be considered as the indication of the maintenance mode operation of the elevator car 110.

At a step 340, in response to the detection of the at least one deviation between the obtained motion data and the respective at least one reference motion profile, the monitoring unit 130 detects, i.e. identifies, the maintenance mode operation of the elevator system 100, i.e. that the elevator system 100 is operating in the maintenance operation mode.

According to an example of the invention, in addition to the detection of the maintenance mode operation of the elevator system 100, one or more defects of the elevator system 100 may be detected in response to the detection of the at least one deviation between the obtained motion data and the respective at least one reference motion profile. For example, correction drives, re-leveling drives, and/or shaft set-up drives of the elevator car 110 may cause at least one deviation in the drive motion profile of the elevator car 110. For example, if the obtained motion data indicates that the elevator car 110 performs several re-levelings, floor magnets may need to be checked for possible defects. The monitoring unit 130 may define based on the at least one deviation 420, e.g. the type and/or amount of the at least one deviation 420, and/or the drive motion profile in which the at least one deviation is detected, whether the at least one deviation between the obtained motion data and the respective at least one reference motion profile indicates the maintenance mode operation of the elevator system 100 or the one or more defects of the elevator system 100. Moreover, the monitoring unit 130 may define the cause of the one or more defects of the elevator system 100 based on the at least one deviation 420, e.g. the type and/or amount of the at least one deviation 420, and/or the drive motion profile in which the at least one deviation is detected.

The monitoring unit 130 may further generate at a step 350 to a remote monitoring unit 140 an indication indicating the maintenance mode operation of the elevator system 100. The generated indication may for example be at least one control signal comprising the indication of the maintenance mode operation of the elevator system 100.

Furthermore, in response to receiving the indication from the control unit 130 the remote monitoring unit 140 may ignore, i.e. omit, subsequent fault codes from said elevator system 100, i.e. from the elevator system 100 from which the indication is received. Alternatively or in addition, the indication may further comprise an instruction for the remote monitoring unit 140 to ignore subsequent fault codes from said elevator system 100, i.e. from the elevator system 100 from which the indication is received. The ignoring may comprise e.g. that service needs are not generated by the remote monitoring unit 140 in response to receiving the subsequent fault codes from the elevator system 100. This enables that unnecessary, i.e. incorrect, fault codes caused by one or more maintenance related operations performed by the at least one maintenance person during a maintenance visit to the elevator system 100, do not lead to a generation of unnecessary, i.e. incorrect, service needs by the remote monitoring unit 140. This, in turn, may increase accuracy of the generated service needs and decrease unnecessary maintenance visits.

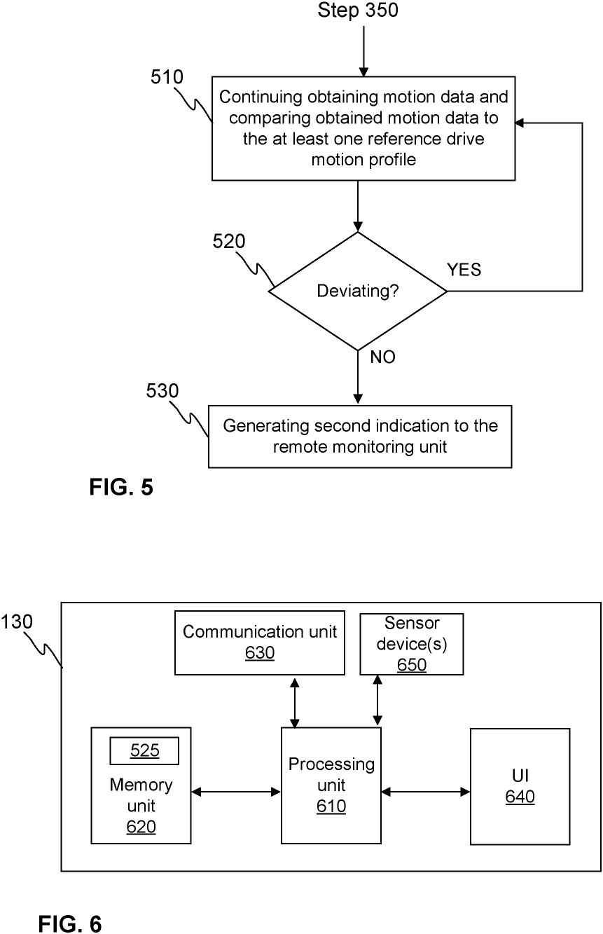

FIG. 5 illustrates schematically an example embodiment of the method according to the invention. At a step 510, after the generating the indication to the remote monitoring unit 140 at the step 350, the control unit 130 may continue the obtaining of the motion data and comparing the obtained motion data to the at least one respective reference drive motion profile of the elevator car 110 similarly as described above referring to the steps 310 and 320.

At a step 520, the control unit 130 may detect ending of the deviation between the obtained motion data and the at least one respective reference drive motion profile of the elevator car 110. In other words, the control unit 130 may detect that the elevator system 100 is not operating in the maintenance operation mode anymore.

At a step 530, in response to the detecting ending of the deviation between the obtained motion data and the at least one respective reference drive motion profile of the elevator car 110, the control unit 130 may generate a second indication to the remote monitoring unit 140. The second indication may indicate an ending of the maintenance mode operation of the elevator system 100, i.e. that the elevator system 100 is not operating in the maintenance mode anymore, and/or that the elevator system 100 is operating in the normal operation mode again. The generated second indication may for example be at least one second control signal comprising the indication of ending of the maintenance mode operation of the elevator system 100 and/or the normal operation mode of the elevator system 100.

The remote monitoring unit 140 may terminate the ignoring of the subsequent fault codes from said elevator system 100, i.e. from the elevator system 100 from which the second indication is received, in response to receiving the second indication from the control unit 130. Alternatively or in addition, the second indication may further comprise an instruction for the remote monitoring unit 140 to terminate the ignoring of the subsequent fault codes from said elevator system 100, i.e. from the elevator system 100 from which the second indication is received.

According to an example of the invention, the monitoring unit 130 may further obtain door data from a door sensor device arranged to at least one door of the elevator car 110. The door sensor unit may be communicatively coupled to the monitoring unit 130. The communication between the door sensor unit and the monitoring unit 130 may be based on one or more known communication technologies, either wireless or wired. In the maintenance operation mode elevator calls, e.g. landing calls and/or elevator car calls, and door operations are disabled. Thus, if the monitoring unit 130 detects based on the obtained door data that the at least one door remains closed after the drive, it provides a further indication of the maintenance mode operation of the elevator system 100. This enables a use of additional information about the door state in the detection of the maintenance mode operation of the elevator system 100, which in turn improves accuracy and sensitivity of the detection of the maintenance mode operation of the elevator system 100. The monitoring unit 130 may further provide the further indication of the maintenance mode operation of the elevator system 100 to the remote monitoring unit 140.

Alternatively or in addition, the detection of the maintenance mode operation of the elevator system 100 as described above enables that recorded sound samples during the maintenance mode operation of the elevator system 100 by the at least one microphone of the monitoring unit 130 may be provided to the remote monitoring unit 140 and/or one or more databases. The sound sample may for example be used for data analytics, e.g. detected energy and frequencies when a counterweight passes the at least one microphone may be used for inspecting a condition of counterweight sliding guide shoes and/or bearings, and/or a detected sharp noise at a specific position inside the elevator shaft 120, e.g. at a specific landing, may be used for detecting that something is hitting the elevator car 110 at that position.

Alternatively or in addition, the detection of the maintenance mode operation of the elevator system 100 as described may be used in a definition of an availability time of the elevator system 100. For example, a maintenance time of the elevator system 100, i.e. a duration of the maintenance mode operation of the elevator system 100, may be defined based on the detection of the maintenance mode operation of the elevator system 100 and the detection of the ending of the maintenance mode operation of the elevator system 100. The maintenance time of the elevator system 100 may be used in the definition of the availability time of the elevator system 100. The availability time of the elevator system 100 may be defined for example based on the following definition: availability = (a running time + a waiting time - a faulted time - the maintenance time) / total time.

FIG. 6 schematically illustrates an example of components of the monitoring unit 130 according to the invention. The monitoring unit 130 may comprise a processing unit 610 comprising one or more processors, a memory unit 620 comprising one or more memories, a communication unit 630 comprising one or more communication devices, and possibly a user interface (UI) unit 640. The mentioned elements may be communicatively coupled to each other with e.g. an internal bus. The memory unit 620 may store and maintain portions of a computer program (code) 625 and any other data. The computer program 625 may comprise instructions which, when the computer program 625 is executed by the processing unit 610 of the monitoring unit 130 may cause the processing unit 610, and thus the monitoring unit 130 to carry out desired tasks, e.g. the operations of the monitoring unit 130 and/or at least some of the method steps described above. The processing unit 610 may thus be arranged to access the memory unit 620 and retrieve and store any information therefrom and thereto. For sake of clarity, the processor herein refers to any unit suitable for processing information and control the operation of the monitoring unit 130, among other tasks. The operations may also be implemented with a microcontroller solution with embedded software. Similarly, the memory unit 620 is not limited to a certain type of memory only, but any memory type suitable for storing the described pieces of information may be applied in the context of the present invention. The communication unit 630 provides an interface for communication with any external unit, e.g. the remote monitoring unit 140, one or more databases, and/or any other external unit. The communication unit 630 may be based on one or more known communication technologies, either wired or wireless, in order to exchange pieces of information. The communication unit 630 may comprise one or more communication devices e.g. at least one radio transceiver, at least one antenna, etc. The one or more user interface units 640 may comprise one or more input/output (I/O) devices, such as buttons, keyboard, touch screen, microphone, loudspeaker, display and so on, for receiving user input and outputting information. As discussed above, the monitoring unit 130 may further comprise one or more sensor devices 650. The computer program 625 may be a computer program product that may be comprised in a tangible non-volatile (non-transitory) computer-readable medium bearing the computer program code 625 embodied therein for use with a computer, i.e. the control unit 130.

The specific examples provided in the description given above should not be construed as limiting the applicability and/or the interpretation of the appended claims. Lists and groups of examples provided in the description given above are not exhaustive unless otherwise explicitly stated.

1. A method for detecting a maintenance mode operation of an elevator system, the method comprising the steps of:
obtaining, by a monitoring unit being a separate unit arranged to an elevator car of the elevator system, motion data of the elevator car representing at least one drive motion profile of the elevator car;
comparing, by the monitoring unit, the obtained motion data to at least one respective reference motion profile of the elevator car;
detecting, by the monitoring unit, at least one deviation between the obtained motion data and the respective at least one reference motion profile, wherein the at least one deviation indicates at least one maintenance related operation; and
detecting, by the monitoring unit, the maintenance mode operation of the elevator system in response to the detection of the at least one deviation.

2. The method according to claim 1, further comprising the step of generating to a remote monitoring unit an indication indicating the maintenance mode operation of the elevator system.

3. The method according to claim 1, wherein the motion data of the elevator car comprises an acceleration profile of the elevator car, a speed profile of the elevator car, a position profile of the elevator car, and/or a jerk profile of the elevator car.

4. The method according to claim 1, wherein each of the at least one reference motion profile of the elevator car represents a motion profile characteristic of the elevator car, when the elevator system is operating in a normal operation mode.

5. The method according to claim 2, wherein the generated indication further comprises an instruction to ignore subsequent fault codes from said elevator system.

6. The method according to claim 5, further comprising the steps of:
continuing the obtaining of the motion data of the elevator car and the comparing of the obtained motion data to the at least one respective reference drive motion profile of the elevator car after the generating the indication:
detecting an ending of the deviation between the obtained motion data and the at least one respective reference drive motion profile; and
generating to the remote monitoring unit a second indication indicating the ending of the maintenance mode operation of the elevator system.

7. The method according to claim 6, wherein the second indication further comprises an instruction to terminate the ignoring of the subsequent fault codes from said elevator system.

8. A monitoring unit for detecting a maintenance mode operation of an elevator system, wherein the monitoring unit is a separate control unit arranged to an elevator car of the elevator system and comprises:
a processing unit; and
a memory unit comprising a computer program code, wherein the memory unit and the computer program code are configured to, with the processing unit, cause the monitoring unit at least to:
obtain motion data representing at least one motion profile of the elevator car;
compare the obtained motion data to at least one respective reference motion profile of the elevator car;
detect at least one deviation between the obtained motion data and the respective at least one reference motion profile, wherein the at least one deviation indicates one or more maintenance related operations: and
detect the maintenance mode operation of the elevator system in response to the detection of the at least one deviation.

9. The monitoring unit according to claim 8, further configured to generate to a remote monitoring unit an indication indicating the maintenance mode operation of the elevator system.

10. The monitoring unit according to claim 8, wherein the motion data comprises an acceleration profile of the elevator car,a speed profile of the elevator car,a position profile of the elevator car,and/or a jerk profile of the elevator car.

11. The monitoring unit according to claim 8, wherein each of the at least one reference motion profile of the elevator car represents a motion profile characteristic of the elevator car,when the elevator system is operating in a normal operation mode.

12. The monitoring unit according to claim 9, wherein the generated indication further comprises an instruction to ignore subsequent fault codes from said elevator system.

13. The monitoring unit according to claim 12, further configured to:
continue the obtaining of the motion data and the comparing of the obtained motion data to the at least one respective reference drive motion profile of the elevator car after generating the indication;
detect an ending of the deviation between the obtained motion data and the at least one respective reference drive motion profile of the elevator car; and
generate to the remote monitoring unit a second indication indicating the ending of the maintenance mode operation of the elevator system.

14. The monitoring unit according to claim 13, wherein the second indication further comprises an instruction to terminate the ignoring of the subsequent fault codes from said elevator system.

15. An elevator system for detecting a maintenance mode operation of an elevator system,the elevator system comprising:
at least one elevator car; and
the monitoring unit according to claim 8.

16. A computer program comprising instructions which, when the program is executed by a control unit, cause the control unit to carry out the method according to claim 1.

17. A tangible non-volatile computer-readable medium comprising the computer program according to claim 16.

18. The method according to claim 2, wherein the motion data of the elevator car comprises an acceleration profile of the elevator car, a speed profile of the elevator car, a position profile of the elevator car, and/or a jerk profile of the elevator car.

19. The method according to claim 2, wherein each of the at least one reference motion profile of the elevator car represents a motion profile characteristic of the elevator car, when the elevator system is operating in a normal operation mode.

20. The method according to claim 3, wherein each of the at least one reference motion profile of the elevator car represents a motion profile characteristic of the elevator car, when the elevator system is operating in a normal operation mode.
